(19) United States
(12) Patent Application Publication
(10) Pub. No.: US 2010/0021862 A1
(43) Pub. Date: Jan. 28, 2010

(54) Novel method and device for positioning patients for dental imaging

(76) Inventor: James Mah, Las Vegas, NV (US)

Correspondence Address: James Mah, P.O. Box 15288, Las Vegas, NV, 89114, US

(21) Appl. No.: 12/220,400

(22) Filed: Jul. 24, 2008

(51) Int. Cl. A61C 19/00

(52) U.S. Cl. 433/140

(57) ABSTRACT

The present invention relates to methods and devices for positioning a patient's head prior to radiographic analysis for orthodontic and dental applications. According to certain embodiments of the invention, such methods comprise disposing a device in the patient's mouth and having the patient bite down on the device. The device used in such methods includes a planar radiolucent material having a mouthpiece in the center portion thereof, which is adjacent to a first concave contour that approximates the patient's left cheek and a second concave contour that approximates the patient's right cheek. The device used in such methods further comprises an outer horizontal edge that extends outwards from the patient's mouth, which is aligned with the patient's occlusal plane. According to certain embodiments, such methods further comprise taking measurements for dental or orthodontic applications relative to the patient's occlusal plane.

### FIELD OF THE INVENTION

The field of the present invention relates to methods and devices for positioning a patient's head prior to radiographic analysis for orthodontic and dental applications.

### BACKGROUND OF THE INVENTION

The introduction of radiographic imaging has led to a multitude of clinical applications across all dental disciplines. The importance of properly positioning a patient's head prior to capturing a radiographic image has been well documented. However, current methods for capturing radiographic images either do not offer specific aids to properly position a patient's head, or employ devices that are ineffective for proper head positioning. For example, some currently-practiced methods involve the use of a bite peg onto which the patient's front teeth bite, or a chin cup onto which a patient will rest his or her chin.

These currently-practiced methods fail to consider a patient's occlusal plane. The position of the patient's head and their teeth are critically important for diagnostic and treatment planning procedures. For some dental procedures, such as implant placement, surgery or orthodontics, the position of the patient's occlusal plane is very important. The occlusal plane is an approximated artificial plane formed by the intersection of the upper and lower teeth. The position of the occlusal plane can be, in certain instances, assessed three-dimensionally to determine the relationship of the teeth to the rest of the head for diagnostic purposes. Moreover, the placement of dental implants or positioning of the teeth in orthodontics is often relative to the occlusal plane.

Accordingly, a need exists for user-friendly and effective means for properly positioning a patient's head prior to radiographic imaging for orthodontic and dental applications, and particularly devices that enable a clinician to consider the location and position of the patient's occlusal plane during such applications.

### SUMMARY OF THE INVENTION

According to a first aspect of the present invention, methods for positioning a patient's head prior to radiographic analysis for orthodontic and dental applications are provided. Such methods comprise temporarily disposing a device in the patient's mouth and having the patient bite down on the device. The device used in such methods includes a planar radiolucent material having a mouthpiece in the center portion thereof, which is adjacent to a first concave contour that approximates the patient's left cheek and a second concave contour that approximates the patient's right cheek. The device used in such methods further comprises an outer horizontal edge that extends outwards from (and is an extension of) the patient's mouth, which is aligned with the patient's occlusal plane. According to certain embodiments, such methods further comprise taking measurements for dental or orthodontic applications relative to the patient's occlusal plane.

According to a second aspect of the present invention, devices for positioning a patient's head prior to radiographic analysis for orthodontic and dental applications are provided. Such devices comprise a planar radiolucent material having a mouthpiece in the center portion thereof, which is adjacent to a first concave contour that approximates the patient's left cheek and a second concave contour that approximates the patient's right cheek. The devices further comprise an outer horizontal edge that extends outwards from the patient's mouth, which is aligned with the patient's occlusal plane. The devices of the present invention may comprise a mouthpiece that includes indentations for receiving a patient's teeth and/or may be comprised of a material that will record the registration of a patient's teeth. The device may further comprise a level, which may be used for leveling a patient's occlusal plane prior to radiographic imaging.

The above-mentioned and additional features of the present invention are further illustrated in the Detailed Description contained herein.

### BRIEF DESCRIPTION OF THE FIGURES

FIG. 1 is top view of the device described herein.

FIG. 2 is a front view of a patient's head, which shows the device disposed in the patient's mouth to be used for head positioning (prior to radiographic imaging).

FIG. 3 is top view of the device described herein, which shows certain dimensions of the device.

FIG. 4 is an elevated front view of a patient's head, which shows the device disposed in the patient's mouth to be used for head positioning (prior to radiographic imaging).

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

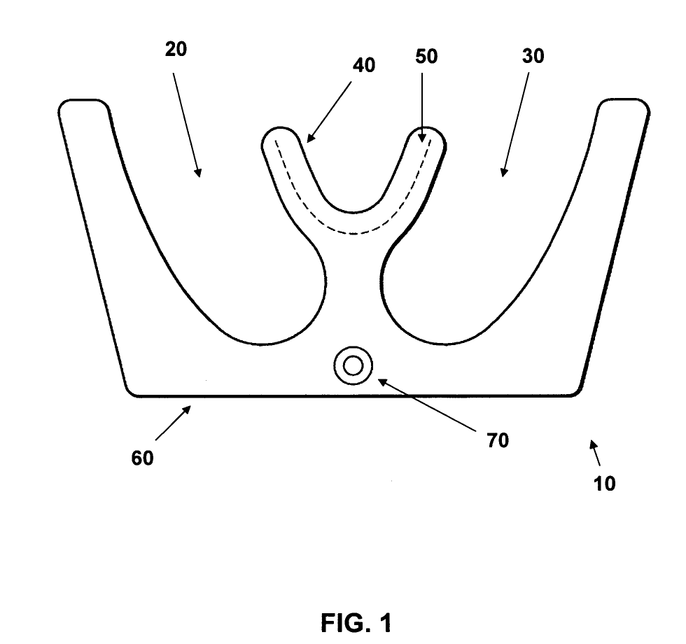

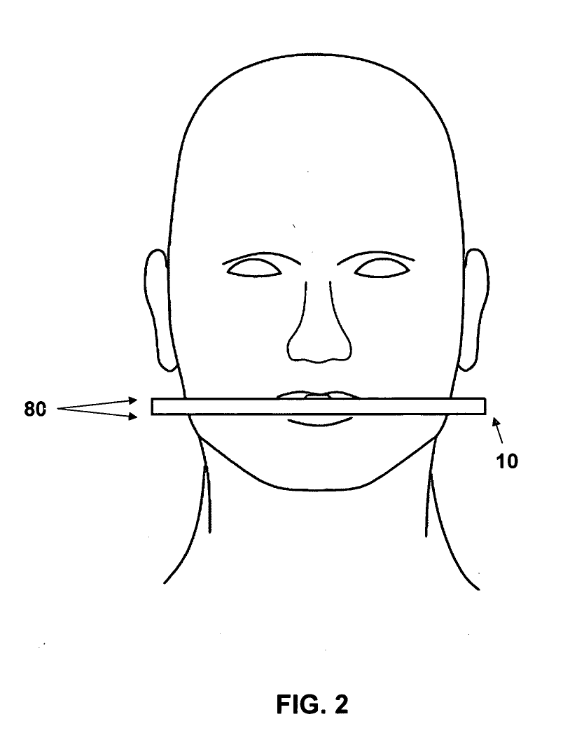

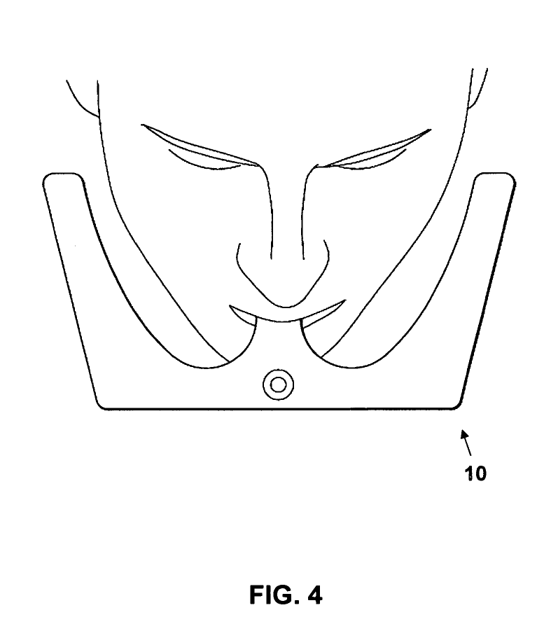

According to certain embodiments of the present invention, methods for positioning a patient's head prior to radiographic analysis for orthodontic and dental applications are provided. The methods generally comprise temporarily disposing a device in a patient's mouth, and having the patient bite down on the device to hold the device therein, while the radiographic image is captured. A non-limiting example of the device is shown in FIG. 1, and FIGS. 2 and 4 show the device disposed in a patient's mouth. Referring to FIG. 1, the device 10 employed in such methods is planar (flat) and is comprised of a generally radiolucent material. As used herein, the term “radiolucent material” refers to a material that appears translucent on x-rays and is not generally visible within the radiograph. Non-limiting examples of such materials include plastics, elastomers, paper, cardboard, foamed polystyrene, glass, combinations of the foregoing, and any other material that does not interfere with radiographic imaging. The device may be manufactured from economical materials, such that the device may be used for a single application and then disposed.

The devices comprise a mouthpiece 40 in the center portion thereof, which is adjacent to a first concave contour 30 that approximates the patient's left cheek and a second concave contour 20 that approximates the patient's right cheek. As used herein, the term “approximates the patient's left/right cheek” means that the subject contour is capable of surrounding the cheek area, while allowing adequate clearance to avoid impingement of the cheek area (which could otherwise interfere with radiographic imaging and proper head alignment). The mouthpiece 40 of the device may, optionally, comprise indentations 50 to receive, and serve as a guide for, the patient's teeth. The indentations may be integral to the device or reversibly added thereto. The indentations (bite guides) 50 will preferably allow the patient's teeth to be inserted therein, which is preferably effective in defining a specific desired biting position. The indentations (bite guides) 50 may be comprised of, for example, acrylic, silicone, composite resin, or combinations thereof.

In addition, according to certain embodiments of the invention, the mouthpiece 40 may comprise a material that will record a registration of the patient's teeth. That is, the mouthpiece 40 may comprise a material that will be malleable such that after the device is removed from a patient's mouth, the indentations created by the patient's teeth will be recorded (retained) in the mouthpiece 40. The retained teeth indentations may be analyzed for dental or orthodontic applications. Non-limiting examples of such materials include wax, silicone, or other similar materials. Preferably, the mouthpiece 40 will approximate the patient's dental arch form.

The invention provides that the device, after being used with a particular patient, may be archived for future use and/or reference by a practitioner (e.g., an orthodontist, dentist, oral surgeon, or other healthcare professional). In such case, the device will preferably be uniquely labeled, in order to correlate the used device with the correct patient. The device may be re-used to, for example, achieve the same occlusal plane and head position prior to capturing a second radiographic image of the same patient. In addition, the invention provides that the device may be modified, e.g., cut, channeled, drilled (to generate localized holes), etc., in order to assist a practitioner in locating an area of a tooth, soft tissue or bone. The practitioner may wish to locate an area of a tooth, soft tissue or bone, in the same patient at a later date, for the purpose of locating or placing a dental implant, inserting a bracket, or for other dental- and/or orthodontic-related applications.

The device described herein further comprises an outer horizontal edge 60 that extends outwards from the patient's mouth (when disposed therein). The horizontal edge 60 will be located on the front and both sides of the device. The outer horizontal edge 60 is preferably aligned with, i.e., it represents and extension of, the patient's occlusal plane. Accordingly, the methods of the present invention may further comprise the step of aligning the patient's occlusal plane to a horizon. In addition, the invention provides that the patient's occlusal plane may be leveled prior to capturing a radiographic image, such as by leveling the device (when disposed in the patient's mouth) using a level 70 disposed on the device. The level may be, for example, a bubble level, a digital level, or any other suitable type of leveling indicator, which is preferably located on the outer horizontal edge 60.

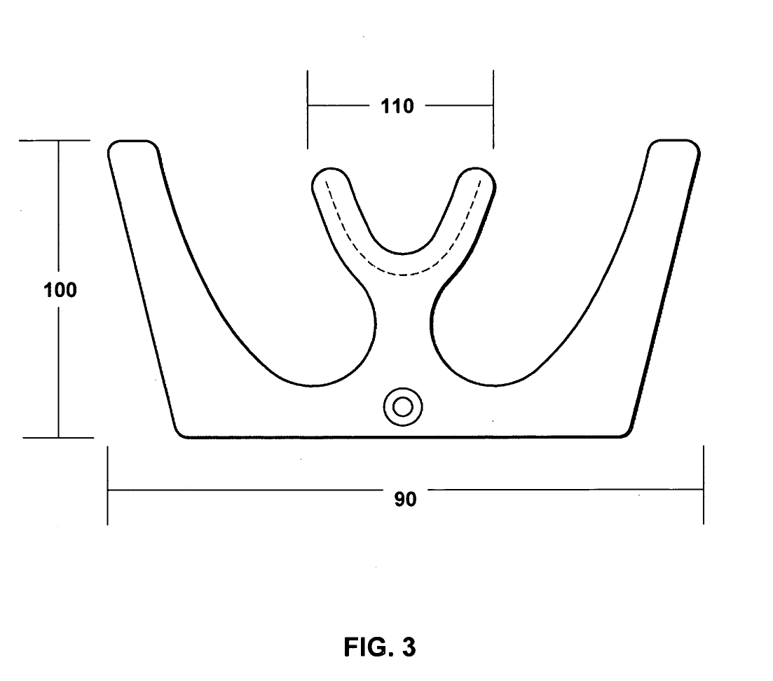

The device of the present invention may exhibit a variety of dimensions, although the dimensions of the device will preferably be optimized for the average size of a patient's head, whether such patient is a child, young adult, or adult. In certain embodiments, for example, and referring to FIG. 3, the device may exhibit a width 100 of about 3 to 7 inches or, particularly, about 4 to 6 inches or, more particularly, about 5.125 inches. In addition, the device may exhibit a length 90 of about 8 to 12 inches or, particularly, about 9 to 11 inches or, more particularly, about 10 inches. The invention further provides that the mouthpiece 40 will have a length 110 of about 2 to 4 inches, such as about 3 inches.

The invention further provides that the devices described herein may be used to reduce the overlap between the patient's upper and lower teeth prior to imaging. By slightly separating the patient's upper and lower teeth, less tooth overlap is present in the radiographic image. This may be of particular value for three-dimensional imaging using, for example, computed tomography or cone-beam computed tomography—as well as when approaches to virtual implant simulation and treatment planning are employed. In such applications, tooth overlap from the opposing dental arch may interfere with visualization of the teeth of interest. In certain embodiments, and referring to FIG. 2, the invention provides that a device having a desired thickness 80, which will be effective in reducing the overlap between the patient's upper and lower teeth by a defined amount, may be selected by a dentist or orthodontist. For example, a device may be selected from a plurality of devices having different thicknesses, such as 0.5, 1, 1.5, 2, 2.5, 3, 4, 5 or more millimeters in thickness 80. In certain preferred embodiments, the device will have a thickness 80 of about ⅛ inch (3.175 mm).

According to certain embodiments, the methods of the present invention further comprise capturing a radiographic image, and taking measurements for dental or orthodontic applications relative to the patient's occlusal plane. If a three-dimensional radiographic image of the patient's head is captured, the invention provides that further cross-sectional images may be extracted that are perpendicular to the occlusal plane. These cross-sectional images will be useful for orthodontic or dental analysis. For example, such cross-sectional images, which are perpendicular to the occlusal plane, have been found to better illustrate a potential dental implant site or tooth position.

Still further, the device 10 may comprise an anterior extension from the outer horizontal edge 60, which may be employed to allow positioning within the radiographic device. The anterior extension may comprise, for example, an interlocking channel, rod or cylinder that is reversibly coupled to the radiographic device. Such design would allow for exact replication of head positioning, prior to imaging, should this be required.

In addition to the methods of positioning a patient's head described herein (prior to radiographic analysis for orthodontic and dental applications), according to further embodiments, the present invention also encompasses the devices described herein. More particularly, the invention encompasses the devices described herein which comprise a planar radiolucent material having a mouthpiece in the center portion thereof, which is adjacent to a first concave contour that approximates the patient's left cheek and a second concave contour that approximates the patient's right cheek. The devices further preferably comprise an outer horizontal edge that extends outwards from the patient's mouth, which is aligned with and is an extension of the patient's occlusal plane. The devices of the present invention may comprise a mouthpiece that includes indentations for receiving a patient's teeth and/or may be comprised of a material that will record the registration of a patient's teeth, as described above. The device may further comprise a level, which may be used for leveling a patient's occlusal plane prior to radiographic imaging.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A method for positioning a patient's head prior to radiographic imaging, which comprises:
(a) disposing a device in the patient's mouth and having the patient bite down on the device, wherein the device comprises:
(i) a planar radiolucent material having a mouthpiece in the center portion thereof, which is adjacent to a first concave contour that approximates the patient's left cheek and a second concave contour that approximates the patient's right cheek; and
(ii) an outer horizontal edge that extends outwards from the patient's mouth which is aligned with the patient's occlusal plane; and
(b) taking measurements for dental or orthodontic applications relative to the patient's occlusal plane.

2. The method of claim 1, which further comprises aligning the patient's occlusal plane to a horizon.

3. The method of claim 2, which further comprises leveling the patient's occlusal plane using a level disposed on the device.

4. The method of claim 2, which further comprises leveling the patient's occlusal plane using a bubble level disposed on the device.

5. The method of claim 4, which further comprises reducing an overlap between the patient's upper and lower teeth by disposing the device in the patient's mouth.

6. The method of claim 5, which further comprises selecting the device having a desired thickness, which will be effective in reducing the overlap between the patient's upper and lower teeth by a defined amount.

7. The method of claim 6, which further comprises the step of capturing a three-dimensional radiographic image of the patient's head, and extracting cross-sectional images that are perpendicular to the occlusal plane for orthodontic or dental analysis.

8. The method of claim 6, which further comprises selecting the device having a mouthpiece that comprises indentations to receive the patient's teeth.

9. The method of claim 6, which further comprises selecting the device having a mouthpiece that comprises a material that will record a registration of the patient's teeth.

10. The method of claim 9, which further comprises selecting the device wherein the mouthpiece approximates the patient's dental arch form.

11. The method of claim 9, which further comprises archiving a used device and (i) re-using the used device in the patient to achieve the same occlusal plane and head position prior to capturing a second radiographic image, (ii) labeling the used device to correlate the used device with the patient, (iii) modifying the used device to assist a practitioner in locating an area of a tooth, soft tissue or bone in which the practitioner will drill, make an incision, or position an orthodontic bracket, or (iv) any combination of the foregoing.

12. A device for positioning a patient's head prior to radiographic imaging, which comprises:
(a) a planar radiolucent material having a mouthpiece in the center portion thereof, which is adjacent to a first concave contour that approximates the patient's left cheek and a second concave contour that approximates the patient's right cheek; and
(b) an outer horizontal edge that extends outwards from the patient's mouth which is aligned with the patient's occlusal plane.

13. The device of claim 12, which further comprises a level disposed on a surface of the device.

14. The device of claim 13, wherein the level is a bubble level.

15. The device of claim 14, wherein the device exhibits a defined thickness for reducing an overlap between the patient's upper and lower teeth.

16. The device of claim 15, wherein the mouthpiece comprises indentations for receiving the patient's teeth.

17. The device of claim 15, wherein the mouthpiece comprises a material that will record a registration of the patient's teeth.

18. The device of claim 17, wherein the mouthpiece approximates the patient's dental arch form.

19. The device of claim 18, which further comprises an anterior extension that is coupled to the outer horizontal edge of the device, which allows positioning within a radiographic device.

20. The device of claim 19, wherein the device is (i) a one-time usage disposable device and (ii) is comprised of plastic, elastomers, paper, cardboard, foamed polystyrene, or combinations thereof.
